(19) United States
(12) Patent Application Publication
(10) Pub. No.: US 2021/0344252 A1
(43) Pub. Date: Nov. 4, 2021

(54) THREE-PHASE GENERATOR WITH ADAPTIVE TAPS FOR USE IN A TRANSPORT CLIMATE CONTROL SYSTEM

(71) Applicant: THERMO KING CORPORATION, Minneapolis, MN (US)

(72) Inventors: Gregory R. Truckenbrod, Minneapolis, MN (US); Musibau Alowonle, Brooklyn Park, MN (US)

(21) Appl. No.: 16/863,463

(22) Filed: Apr. 30, 2020

(51) Int. Cl. H02K 7/18; F25D 11/00; H02K 3/28; H02K 11/00; H02K 11/27

(52) U.S. Cl. CPC H02K 7/1815; F25D 11/003; H02K 11/27; H02K 11/0094; H02K 3/28

(57) ABSTRACT

Technologies described herein are directed to a generator concurrently providing different voltages to multiple components, some of which are unable to receive the full supply voltage output by the generator, without the addition of an electronic power converter or a transformer to the apparatus or system.

### FIELD

The embodiments described herein are directed to power management for systems in transport. More particularly, the embodiments described herein relate to a generator for powering or charging apparatuses and systems pertaining to transport components.

### BACKGROUND

A transport climate control system is generally used to control one or more environmental conditions such as, but not limited to, temperature, humidity, air quality, or combinations thereof, of a transport unit. Examples of transport units include, but are not limited to a truck, a container (such as a container on a flat car, an intermodal container, a marine container, a rail container, etc.), a box car, a semi-tractor, a bus, or other similar transport unit.

### SUMMARY

The embodiments described herein are directed to power management for systems in transport. More particularly, the embodiments described herein relate to a generator for powering or charging apparatuses and systems pertaining to transport components.

The embodiments described herein relate to a generator that may concurrently provide different voltages to multiple components, some of which are unable to receive the full supply voltage output by the generator, without the addition of a transformer to the apparatus or system.

In some embodiments, the transport climate control system may include an energy storage management system designed for a range of voltage and frequency. However, some product requirements may require a supply voltage that is beyond the specified energy storage management system voltage range. The embodiments described herein may provide a generator that supplies voltage that is beyond the specified energy storage management system voltage range to some components (e.g., a compressor, one or more condenser fans, one or more evaporator blowers, etc.) while still allowing the same generator to supply a voltage to the energy storage management system that is within the specified energy storage management system voltage range.

In accordance with at least one example embodiment, a three-phase generator includes an electrical stator winding having multiple coil turns, wherein the electrical stator winding is connected to an electrical load; a distal output power lead that is disposed at a distal end of the electrical stator winding; and at least one intermediate output power lead that is disposed at an intermediate distance between the power source and the distal end of the electrical stator winding, wherein a number of the coil turns determines a generator output voltage at the distal output power lead and at the at least one intermediate output power lead.

In accordance with at least one other example embodiment, a transport climate control system includes a generator that provides three-phase AC voltages, a climate control circuit that includes a compressor that is powered by the prime mover, a first load that is powered in a first mode, and a second load that is powered in a second mode.

### DRAWINGS

References are made to the accompanying drawings that form a part of this disclosure and which illustrate embodiments described in this specification. Various changes and modifications will become apparent to those skilled in the art from the following detailed description. The use of the same reference numbers in different figures indicates similar or identical items.

FIG. 1 illustrates a transport climate control system for a transport unit that is attached to a vehicle, according to at least one embodiment described herein.

FIG. 2 illustrates a block diagram schematic of a three-phase generator for powering transport climate control system elements and components, according to at least one embodiment described herein.

FIG. 3 illustrates an electrical stator, according to at least one embodiment described herein.

### DETAILED DESCRIPTION

The embodiments described herein are directed to power management for systems in transport. More particularly, the embodiments described herein relate to a generator for powering or charging apparatuses and systems pertaining to transport components.

The embodiments described herein relate to a generator that may concurrently provide different voltages to multiple components, some of which are unable to receive the full supply voltage output by the generator, without the addition of a transformer to the apparatus or system.

In particular, on varying AC and DC load requirements may be accommodated by a common generator without invoking a transformer.

In some embodiments, the transport climate control system may include an energy storage management system designed for a range of voltage and frequency. However, some product requirements may require a supply voltage that is beyond the specified energy storage management system voltage range. The embodiments described herein may provide a generator that supplies voltage that is beyond the specified energy storage management system voltage range to some components (e.g., a compressor, one or more condenser fans, one or more evaporator blowers, etc.) while still allowing the same generator to supply a voltage to the energy storage management system that is within the specified energy storage management system voltage range.

The embodiments described herein may accommodate load requirements that are less than that output by a single source, without an additional power factor correction circuit. For example, an inductive load (e.g., a transformer, an induction machine, etc.) may have a lagging current that requires reactive power for magnetization. The reactive current required may be too high for lightly loaded machines, and the added current for reactive power may create power losses in the power management system because current and voltage are not in phase and because the current may not be sinusoidal.

Accordingly, the embodiments described and recited herein improve power efficiency of the power management system in transport. In some embodiments, this may create fuel savings for the power management system, assist the power management system to meet power quality regulation, facilitate increased reliability, and at a lower cost, by using an existing generator, thus eliminating the need for additional components, e.g., an electronic power converter or a transformer.

In the following detailed description, reference is made to the accompanying drawings, which are included as a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

While the embodiments described below illustrate different embodiments of a transport climate-control system, it will be appreciated that the electrically powered accessory is not limited to the transport climate-control system or a climate control unit (CCU) of the transport climate-control system. A CCU may be, e.g., a transport refrigeration unit (TRU). In other embodiments, the electrically powered accessory may be, for example, a crane attached to a vehicle, a cement mixer attached to a truck, one or more food appliances of a food truck, a boom arm attached to a vehicle, a concrete pumping truck, a refuse truck, a fire truck (with a power driven ladder, pumps, lights, etc.), etc. The electrically powered accessory may require continuous operation even when the vehicle's ignition is turned off and/or the vehicle is parked, idling, and/or charging. The electrically powered accessory may further require substantial power to operate, continuous operation, and/or autonomous operation (e.g., controlling temperature/humidity/airflow of a climate-controlled space) on an as needed basis, independent of the vehicle's operational mode.

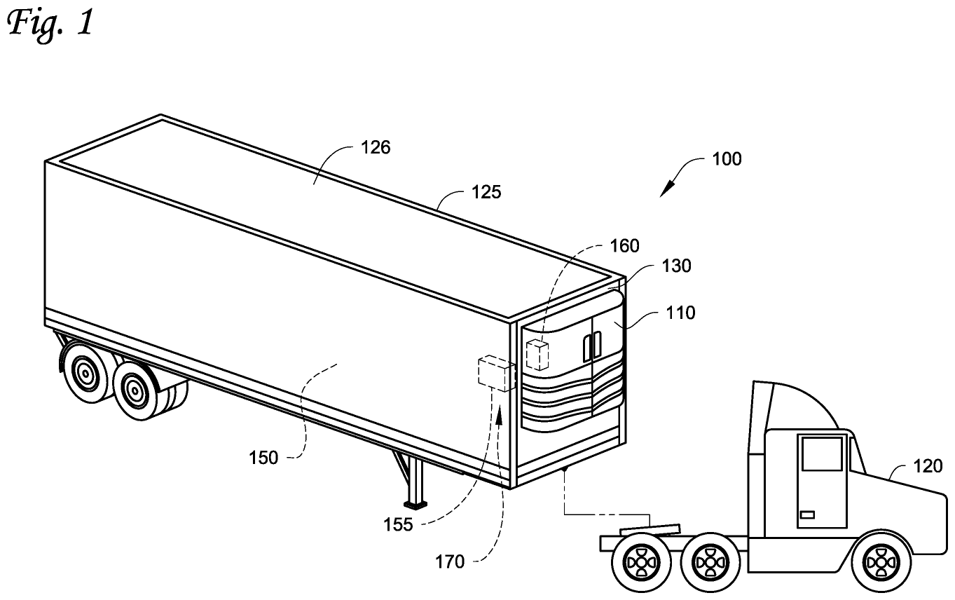

FIG. 1 illustrates one embodiment of a transport climate control system 100 for a transport unit (TU) 125 that is attached to a tractor 120. The transport climate control system 100 includes a CCU 110 that provides environmental control (e.g. temperature, humidity, air quality, etc.) within an internal space 150 of the TU 125. The transport climate control system 100 also includes a transport climate control system controller 170 and one or more sensors (not shown) that are configured to measure one or more parameters of the transport climate control system 100 and communicate parameter data to the transport climate control system controller 170.

The CCU 110 is disposed on a front wall 130 of the TU 125. In other embodiments, it will be appreciated that the CCU 110 may be disposed, for example, on a rooftop 126 or another wall of the TI 125. The tractor 120 is attached to, and is configured to tow, the transport unit 125. It will be appreciated that the embodiments described herein are not limited to trucks and trailer units, but also apply to any other type of transport unit (e.g., a container on a flat car, an intermodal container, etc.), a truck, a box car, or other similar transport unit.

The programmable transport climate control system Controller 170 may comprise a single integrated control unit 160 or may comprise a distributed network of transport climate control system control elements 160, 165. The number of distributed control elements in a given network may depend upon the particular application of the principles described herein. The transport climate control system controller 170 is configured to control operation of the transport climate control system 100. The transport climate control system controller 170 may also regulate the operation of the transport climate control system 100 to prevent overloading a power source (e.g. a diesel engine) during an operational mode change of the transport climate control system, as described in more detail below.

The transport climate control system 100 may be powered by one or more power sources (not shown) including for example, a prime mover (e.g., diesel engine), a generator set, shore power, a fuel cell, solar power panel, etc. In at least one other embodiment, one or more of the power sources (e.g., a prime mover, a fuel cell, etc.) may be disposed within the CCU 110. In at least one other embodiment, one or more of the power sources may be separate from the CCU 110 and disposed within the tractor 125 (e.g., a prime mover for moving the tractor 120, etc.) or CCU 110. In other embodiments, one or more of the power sources may be on, attached to, or within the TU 120 (e.g., a generator set, a solar power panel, etc.). Also, in some embodiments, one or more of the power sources may be outside of the CCU 110, the TU 120 and the tractor 125 (e.g., shore power, etc.).

When the power source includes a diesel engine, the diesel engine may be less than a 25 horse power engine. Also, the diesel engine may be a two speed engine, a variable speed engine, etc. In some instances, the power source may be required to not exceed a predefined power level. Exceeding the predefined power level may, for example, prevent the power source from overloading, may prevent the power source from exceeding, for example, government or customer requirements (e.g., noise level regulations, emission regulations, fuel usage limits, etc.).

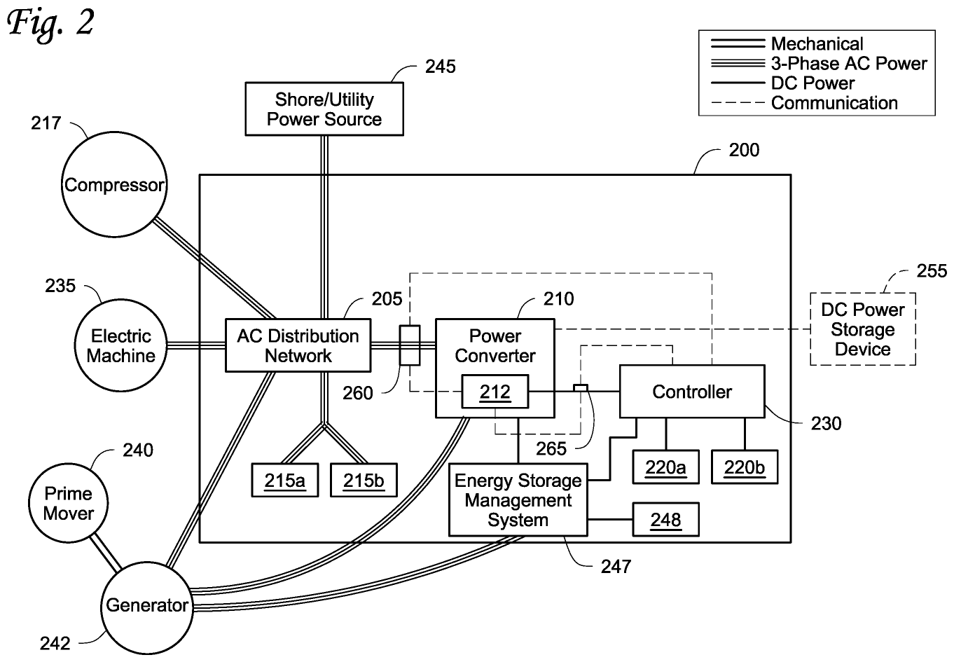

FIG. 2 illustrates a block diagram schematic of one embodiment for a power management system 200 for powering, e.g., transport climate control system 100. System 200 includes an AC distribution network 205; a power converter 210; a plurality of varying AC loads 215a, 215b; a plurality of varying DC loads 220a, 220b; a transport climate control system controller 230; a power converter input sensor 260; and a power converter output sensor 265. The embodiment shown in FIG. 2 and described herein, and the quantity of features including, but not limited to AC loads 215a and 215b, and DC loads 220a and 220b are not so limited. That is, the embodiment shown in FIG. 2 and described herein is a non-limiting example.

AC distribution network 205, in accordance with at least one embodiment, may be configured to receive three phase AC power from an electric machine 235 excited by the AC distribution network 205 and powered by a prime mover 240 (e.g., when the transport climate control system is in transport), a generator 242 powered by the prime mover 240 (e.g., when the transport climate control system is in transport), and/or from a shore/utility power source 245 (e.g., when the transport climate control system is not in transport).

The prime mover 240 may be, for example, a diesel engine, a compressed natural gas engine, etc. In some embodiments, the prime mover 240 may generate power for the power management system 200 as well as other loads. For example, in at least one embodiment, the prime mover 240 may be used for operating a vehicle, and the power management system 200 may only obtain variable amounts of power from the prime mover 240 based on the power required for operating the vehicle. In at least one other embodiment, the prime mover 240 may be disposed in CCU 110 of the transport climate control system. In some embodiments, the prime mover 240 may be disposed in a tractor/truck that provides transport for the transport climate control system.

The electric machine 235 may be and/or include, for example, an induction machine (e.g., an asynchronous induction machine), a motor, etc.

The generator 242 is configured to supply power to the AC distribution network 205. In some embodiments, the generator 242 may be part of and/or disposed within a CCU (e.g., the CCU 110 shown in FIG. 1. In other embodiments, the generator 242 may be part of a generator set that is separate and distinct from a CCU. In these embodiments, the generator set may be, for example, attached/disposed on a transport unit (e.g., the TU 120).

Embodiments of generator 242 may be a split-phase power system that facilitates high conductor efficiency and low safety risk by splitting the voltage generated thereby into lesser parts to thereby power multiple loads at those lesser voltages, all while drawing current from, e.g., prime mover 240, at levels that may be typical of a full-voltage system.

In accordance with multiple embodiments described and recited herein, generator 242 may include a three-phase generator, which may have increased utility in commercial and industrial use by generating three alternating currents to ensure continuous power generation and allowing for a balance power mode.

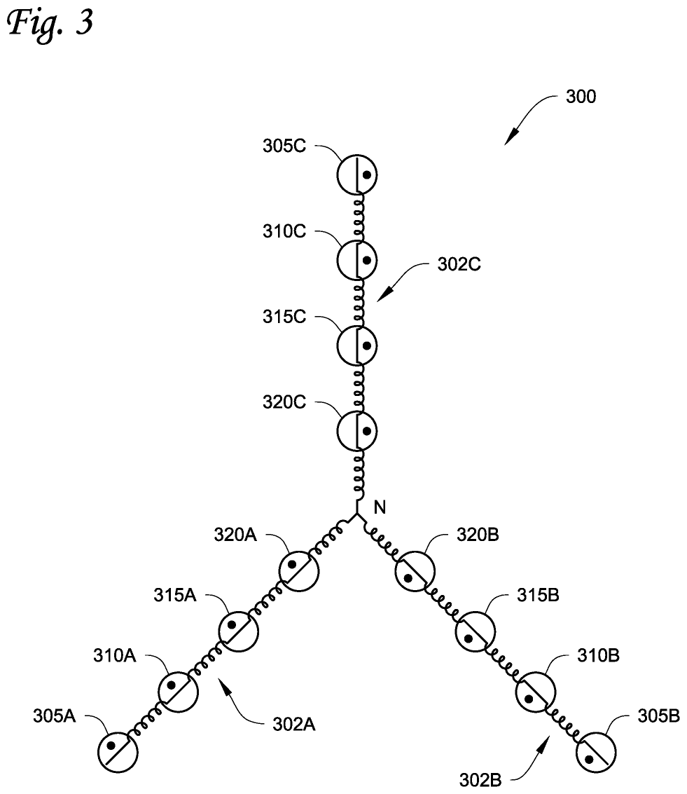

Three-phase generator 242 may have connected thereto multiple electrical stator windings, each having multiple coil turns (see FIG. 3). In accordance with multiple embodiments described and recited herein, the electrical stator windings may be configured in a Y-configuration (see FIG. 3), of which each electrical stator winding may have at least three simultaneously-powered output lines, alternatively referred to as wires or conductors, connected to and leading away from the power source of the generator, to provide a proportion of the full output voltage of the generator. All voltage outputs may be protected by an existing stator overload protector (not shown), and full-rated generator output current may be available for the windings.

That is, each electrical stator winding may include a distal output power lead or tap that is disposed at a distal end of the electrical stator winding to provide the full output voltage of the generator to a load connected thereto; at least one intermediate output power lead that is disposed at an intermediate distance between the power source and the distal end of the electrical stator winding to provide a proportion, e.g., 25%, 50%, and/or 75%, of the full output voltage of generator 242. The number of coil turns, or windings, from the power source of generator 242 to the respective output power leads is determinative of the proportion of the full output voltage of the generator to a load connected to the respective lead.

In accordance with at least some embodiments described and recited herein, one or more of the loads connected to an intermediate output power lead may include an energy storage management system and/or a compressor. However, the embodiments are not so limited. The loads that may be connected to an intermediate output power lead may include, in any combination or permutation, a fan motor, a heater, controllers, etc.

Accordingly, one or more of the embodiments described and recited herein pertains to the generator 242 providing three-phase AC voltages, a climate control circuit that includes a compressor 217 that may be electrically powered by the three-phase generator 242, a first load that is powered in a first mode, and a second load that is powered in a second mode.

The one or more embodiments may pertain to a transport climate control system for which the first mode is a first voltage level delivered by a first tap on a respective one of the wires, and the second mode is a second voltage level delivered by a second tap on a respective one of the wires, thus delivering any one of e.g., 25%, 50%, and/or 75%, of the full output voltage of generator 242 to a load connected to the respective tap.

In at least one embodiment of transport climate control system 100, one or more of the electric machine 235, the generator 242, the prime mover 240 and the compressor 217 may be part of the power management system 200.

AC distribution network 205 may be configured to direct three-phase AC power to the power converter 210, compressor 217, and the plurality of varying AC loads 215a and 215b.

Generator 242 may supply three-phase AC power to power converter 210, compressor 217, and other AC loads 215a, 215b, etc., which may include, but not be limited to, condenser fan motors, evaporator blowers, drain tube heaters, heater connections, controllers, and energy storage management system 247. At least one embodiment of transport climate control system 100 may include energy storage management system 247 that is powered by generator 242 in either of the first mode or the second mode. Power drawn by each of the plurality of AC loads 215a and 215b may vary over time based on, for example, needs and operation of the transport climate control system 100.

The energy storage management system 247 may receive AC power from the generator 242 and may supply power via a rechargeable energy storage source (RESS) 248, to the power converter 210, to the transport climate control system controller 230 as well as various other components of the transport climate control system that require DC power. The energy storage management system 247 is configured to monitor a charge level of one or more batteries of the RESS 248 and charge the one or more batteries of the RESS 248. The energy storage management system 247 may communicate with, for example, the transport climate control system controller 230 to provide a charge level of one or more batteries of the RESS 248. Also, the energy storage management system 247 may receive instructions from, for example, the transport climate control system controller 230 indicating the amount of power from the RESS 248 should be supplied to the components of the transport climate control system. In some embodiments, the energy storage management system 247 may be a battery charger. Also, in some embodiments, the energy storage management system 247 may have a specified voltage range between 180 VAC and 506 VAC.

In some embodiments, the RESS 248 may include one or more batteries. For example, in one embodiment the RESS 248 may include two batteries (not shown). Each of the batteries may also be connected to the power converter 210 via the energy storage management system 247. It will be appreciated that the RESS 248 may provide sufficient energy to power the transport climate control loads by itself. In some embodiments, the RESS 248 may provide 12 VDC or 24 VDC. In other embodiments, the RESS 248 may provide 48 VDC.

In some embodiments, the generator 242 may supply voltage that is beyond the specified voltage range of the energy storage management system 247 to some components (e.g., compressor 217, one or more condenser fans, one or more evaporator blowers, etc.) while still allowing the same generator to supply a voltage within the specified voltage range to the energy storage management system 247 that is within the specified energy storage management system voltage range.

As a non-limiting example, when operating at any operating frequency, the generator 242 may supply 537 VAC (ranging between 483 VAC and 590 VAC). When the specified voltage range of the energy storage system 247 is between 180 VAC and 506 VAC, there is a possibility that the generator 242 may supply a voltage that goes beyond 506 VAC. As discussed above and in more detail with respect to FIG. 3, the energy storage management system 247 may be connected to an intermediate output power lead of the generator 242 so that the maximum voltage received by the energy storage management system 247 is within the specified voltage range of the energy storage management system (e.g., between 180 VAC and 506 VAC). In this example, when the energy storage management system 247 is connected to an intermediate output power lead of the generator 242 that supplies 75% of the full output voltage of generator 242, the energy storage management system 247 may receive between 362 VAC and 443 VAC.

The transport climate control system controller 230 is an electronic device that is configured to manage, command, direct, and regulate the behavior of one or more transport climate control system climate control components of a climate control circuit (e.g., an evaporator, a condenser, the compressor 217, an expansion valve (EXV), an electronic throttling valve (ETV), etc.), the plurality of varying AC loads 215a and 215b, the plurality of varying DC loads 220a and 220b, electric machine 235, etc. Although not shown, the transport climate control system controller 230 is also configured to communicate with the power converter controller 210 for providing power management for the transport climate control system.

Compressor 217 may be a refrigerant compressor that compresses refrigerant for use in, for example, a climate control circuit. In accordance with one or more embodiments described and recited herein, the compressor 217 may be electrically driven, receiving electric power from either of three-phase generator 242 or AC distribution network 205. Alternatively, compressor 217 may be mechanically driven, receiving mechanical power from the prime mover 240 and/or the electric machine 235.

The power converter 210 may receive three-phase AC power from generator 242, in accordance with at least one embodiment described and recited herein. In addition, or alternatively, power converter 210 may receive three-phase AC power from prime mover 240 and/or shore/utility power source 245. The power converter 210 is configured to convert the received three-phase AC power into DC power and supply the DC power to the varying DC loads 220 via the transport climate control system controller 230. While the embodiment shown in FIG. 2 shows the power converter 210 supplying DC power to the plurality of varying DC loads 220 via the transport climate control system controller 230, it will be appreciated that in other embodiments the power converter 210 may supply DC power to one or more of the plurality of varying DC loads 220 without passing through the transport climate control system controller 230. In some embodiments, the power converter 210 may also supply DC power to an optional DC power storage device 255. The power converter 210 is controlled by a power converter controller 212.

It will be appreciated that the three-phase AC power received by the power converter 210 is a varying three phase AC power signal that may vary over time based on, for example, changing load requirements from the plurality of varying AC loads 215a and 215b, changing three-phase AC power supplied by the electric machine (e.g., because of changing load requirements from the compressor 217, changing power generated by the prime mover 240, etc.).

The power converter 210 is also configured to supplement three-phase AC current provided by the electric machine 235, the shore/utility power source 245, and/or the generator 242 to the varying AC loads 215a and 215b with reactive three phase AC current to help reduce power efficiency losses.

FIG. 3 illustrates an electrical stator 300, according to at least one embodiment described herein.

In accordance with at least one embodiment of electrical stator 300, corresponding to three-phase generator 242, electrical stator windings 302 may be configured in a Y-configuration. Each electrical stator winding 302A, 302B and 302C may have at least three simultaneously-powered output lines, alternatively referred to as wires or conductors, connected to and leading away from the power source of the generator, to provide a proportion of the full output voltage of the generator. All voltage outputs may be protected by an existing stator overload protector (not shown), and full-rated generator output current may be available for the windings. Further, an overcurrent protector may be provided to cover a converging point of the multiple emanating wires, e.g., at the convergence point of the Y-configuration.

In the embodiment of FIG. 3, each electrical stator winding 302A, 302B and 302C may include a distal output power lead or tap 305A, 305B, and 305C that is disposed at a distal end of the respective electrical stator winding 302A, 302B and 302C to provide the full output voltage of generator 242 to a load connected thereto.

Further, each electrical stator winding 302A, 302B and 302C may include a distal output power lead or tap may include at least one intermediate output power lead that is disposed at an intermediate distance between the power source and the distal end of the electrical stator winding 302A, 302B and 302C to provide a proportion of the full output voltage of generator 242.

Thus, in the embodiment of FIG. 3, intermediate output power lead or tap 310A, 310B, and 310C on the respective electrical stator windings 302A, 302B and 302C provide 75% of the full output voltage of generator 242 to a load connected thereto; intermediate output power lead or tap 315A, 315B, and 315C on the respective electrical stator windings 302A, 302B and 302C provide 50% of the full output voltage of generator 242 to a load connected thereto; and intermediate output power lead or tap 320A, 320B, and 320C on the respective electrical stator windings 302A, 302B and 302C provide 25% of the full output voltage of generator 242 to a load connected thereto.

The number of coil turns, or windings, from the power source of generator 242 to the respective output power leads is determinative of the proportion of the full output voltage of the generator to a load connected to the respective lead.

Accordingly, the generator 242 may concurrently provide different voltages to multiple components, some of which are unable to receive the full supply voltage output by the generator 242 (e.g., the energy storage management system 247), without the addition of an electronic power converter or a transformer to the apparatus or system.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

### ASPECTS

It is to be appreciated that any of the following aspects may be combined:

Aspect 1. A three-phase generator, comprising:

an electrical stator winding having multiple coil turns,
wherein the electrical stator winding is connected to an electrical load,

a distal output power lead disposed at a distal end of the electrical stator winding; and

at least one intermediate output power lead disposed at an intermediate distance between the power source and the distal end of the electrical stator winding,
wherein a number of the coil turns determines a generator output voltage at the distal output power lead and at the at least one intermediate output power lead.

Aspect 2. The three-phase generator of Aspect 1, wherein a position of the at least one intermediate output power lead determines a proportion of a full generator output voltage provided to a receptacle.

Aspect 3. The three-phase generator of Aspect 1 or Aspect 2, wherein the intermediate distance is based on the number of coil turns from the power source to a placement of the at least one output power lead.

Aspect 4. The three-phase generator of any one of Aspects 1-3, wherein the at least one intermediate output power lead provides any one of 25%, 50%, or 75% of the generator output voltage.

Aspect 5. The three-phase generator of any one of Aspects 1-4, wherein the three-phase generator is used in a portable transport system.

Aspect 6. The three-phase generator of any one of Aspects 1-5, wherein the at least one intermediate output power lead is connected to an energy storage management system.

Aspect 7. A transport climate control system, comprising:

a generator that provides three-phase AC voltages;

a climate control circuit that includes a compressor that is powered by the three-phase generator;

a first load that is powered in a first mode; and

a second load that is powered in a second mode,

wherein the generator is configured to concurrently provide a first voltage to the first load and a second voltage to the second load, wherein the first voltage is greater than the second voltage.

Aspect 8. The transport climate control system of Aspect 7, wherein the three-phase generator comprises:

multiple emanating wires, each of the wires having multiple windings; and

taps that are equally and proportionally distributed over each of the multiple wires to deliver output voltages that are less than 100% of a voltage output by the three-phase generator.

Aspect 9. The transport climate control system of Aspect 7 or Aspect 8,

wherein the first mode is the first voltage level delivered by a first tap on a respective one of the wires, and

wherein the second mode is the second voltage level delivered by a second tap on a respective one of the wires.

Aspect 10. The transport climate control system of any one of Aspects 7-9, further comprising:

an energy storage management system that is powered in either of the first mode or the second mode.

Aspect 11. The transport climate control system of any one of Aspects 7-10, wherein the taps disposed on the respective wires deliver any one of 25%, 50%, or 75% of the voltage output from the power source.

Aspect 12. The transport climate control system of any one of Aspects 7-11, wherein the three-phase generator is used to power any one of a fan motor, a vehicle heater, or a controller.

Aspect 13. The transport climate control system of any one of Aspects 7-12, wherein each tap on each of the respective wires is simultaneously powered.

Aspect 14. The transport climate control system of any one of Aspects 7-13, wherein the at least one tap on each of the respective wires includes an overcurrent protector.

Aspect 15. The transport climate control system of any one of Aspects 7-14, wherein an overcurrent protector covers a converging point of the multiple emanating wires.

The terminology used in this specification is intended to describe particular embodiments and is not intended to be limiting. The terms “a,” “an,” and “the,” or even the absence of such modifiers, may refer to the plural forms as well, unless clearly indicated otherwise. The terms “includes,” “including,” “comprises” and/or “comprising,” when used in this specification, indicate the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts, without departing from the scope of the present disclosure. The word “embodiment” as used within this specification may, but does not necessarily, refer to the same embodiment. This specification and the embodiments described are examples only. Other and further embodiments may be devised without departing from the basic scope thereof, with the true scope and spirit of the disclosure being indicated by the claims that follow.

1. A three-phase generator for supplying power to a component of a transport climate control system, the three-phase generator comprising:
an electrical stator winding having multiple coil turns,
wherein the electrical stator winding is connected to an electrical load,
a distal output power lead disposed at a distal end of the electrical stator winding; and
at least one intermediate output power lead disposed at an intermediate distance between the power source and the distal end of the electrical stator winding,
wherein a number of the coil turns determines a generator output voltage at the distal output power lead and at the at least one intermediate output power lead.

2. The three-phase generator of claim 1, wherein a position of the at least one intermediate output power lead determines a proportion of a full generator output voltage provided to a load.

3. The three-phase generator of claim 2, wherein the intermediate distance is based on the number of coil turns from the power source to a placement of the at least one output power lead.

4. The three-phase generator of claim 2, wherein the at least one intermediate output power lead provides any one of 25%, 50%, or 75% of the generator output voltage.

5. The three-phase generator of claim 2, wherein the three-phase generator is used in a portable transport system.

6. The three-phase generator of claim 5, wherein the at least one intermediate output power lead is connected to an energy storage management system.

7. A transport climate control system, comprising:
a generator that provides three-phase AC voltages;
a climate control circuit that includes a compressor that is powered by the three-phase generator;
a first load that is powered in a first mode; and
a second load that is powered in a second mode,
wherein the generator is configured to concurrently provide a first voltage level to the first load and a second voltage level to the second load, wherein the first voltage is greater than the second voltage.

8. The transport climate control system of claim 7, wherein the three-phase generator comprises:
multiple emanating wires, each of the wires having multiple windings; and
taps that are equally and proportionally distributed over each of the multiple wires to deliver output voltages that are less than 100% of a voltage output by the three-phase generator.

9. The transport climate control system of claim 8,
wherein the first mode is the first voltage level delivered by a first tap on a respective one of the wires, and
wherein the second mode is the second voltage level delivered by a second tap on a respective one of the wires.

10. The transport climate control system of claim 8, further comprising:
an energy storage management system that is powered in either of the first mode or the second mode.

11. The transport climate control system of claim 8, wherein the taps disposed on the respective wires deliver any one of 25%, 50%, or 75% of the voltage output from the power source.

12. The transport climate control system of claim 7, wherein the three-phase generator is used to power any one of a fan motor, a vehicle heater, or a controller.

13. The transport climate control system of claim 8, wherein each tap on each of the respective wires is simultaneously powered.

14. The transport climate control system of claim 8, wherein the at least one tap on each of the respective wires includes an overcurrent protector.

15. The transport climate control system of claim 8, wherein an overcurrent protector covers a converging point of the multiple emanating wires.
